(19) United States
(12) Patent Application Publication
(10) Pub. No.: US 2020/0238420 A1
(43) Pub. Date: Jul. 30, 2020

(54) CONTROL SYSTEM USING LIGHT SIGNAL FEEDBACK TO GUIDE WELDING OPERATIONS

(71) Applicant: EDWARD F. SAVAGE, Belmont, CA (US)

(72) Inventor: EDWARD F. SAVAGE, Belmont, CA (US)

(73) Assignee: NORTHROP GRUMMAN SYSTEMS CORPORATION, FALLS CHURCH, VA (US)

(21) Appl. No.: 16/258,159

(22) Filed: Jan. 25, 2019

(51) Int. Cl. B23K 9/095; B23K 9/32; G01S 17/08; G01P 3/36

(52) U.S. Cl. CPC B23K 9/0956; B23K 9/0953; G01P 3/36; G01S 17/08; B23K 9/322

(57) ABSTRACT

A welding control system includes a tip sensor to collect welding data from a welding tip. A controller receives the welding data from the tip sensor. The controller compares the welding data to welding parameter thresholds to determine a correction signal based on the welding data. A light generator generates light signal feedback to a welding operator in response to the correction signal.

### TECHNICAL FIELD

This disclosure relates to welding and control systems that monitor welding parameters of a welding operation and provide feedback to an operator from a light generator that is positioned outside the line of sight of the operator to enable real-time welding adjustments to the welding operation.

### BACKGROUND

Welding is a process that is an integral part in various industries for a variety of types of applications. For example, welding is often performed in applications such as shipbuilding, aircraft repair, construction, and so forth. While these welding operations may be automated in certain contexts, there still exists a need for manual welding operations. In some manual welding operations, it may be desirable to monitor weld parameters, such as the travel speed of the welding torch, throughout the welding operation. While the travel speed of an automated torch may be robotically controlled, the travel speed of the welding torch in manual operations may depend on the operator's welding technique and pattern.

Some attempts have been made to improve manual welding operations by monitoring parameters such as welding travel speed and providing visual or audio feedback to the welding operator regarding the given speed. Audio feedback can be highly disruptive to the operator. As the operator is welding in a given direction, and if their respective travel speed exceeds a given threshold, an audio alarm can sound indicating improper speed and forcing a manual correction. Audio alarms themselves can be disruptive to the welding operation because the sudden presence of sound indicating a travel speed problem can cause the operator to improperly weld at the given welding location due to the disruption caused by the suddenness of the audio event.

In other attempts to aid welding operators, visual feedback such as guided arrows or welding speed numbers are superimposed on to the view of the operator during a given welding operation (e.g., via a display provided in the welding mask). These systems can be highly complicated and expensive such as provided by augmented reality systems. The most significant problem with providing symbolic or numeric information in a display to the operator is that it distracts the operator from focusing on the welding task at hand. Thus, instead of only focusing on the welding joint, the operator is also forced to process additional information from the display which in turn can lower the overall quality of the weld since the operator has become distracted by information presented in the display. Some of these display techniques may also include inserting work-marks on to the items that are being welded and that can lead to an increase in the expense of the overall product.

### SUMMARY

This disclosure relates to a welding and control system using light signal feedback to guide welding operations. In one example, a welding control system includes a tip sensor to collect welding data from a welding tip. A controller receives the welding data from the tip sensor. The controller compares the welding data to welding parameter thresholds to determine a correction signal based on the welding data. A light generator generates light signal feedback to a welding operator in response to the correction signal.

In another example, a device includes a wireless receiver to receive welding data from a welding operation. A controller analyzes the welding data with respect to welding parameter thresholds to determine a correction signal based on the welding data. A light generator generates light signal feedback to a welding operator in response to the correction signal. The light signal feedback includes a variable wavelength of light or a variable intensity of light to communicate the correction signal. An attachment device positions at least the light generator in a welding helmet or welding mask.

In yet another example, a method includes receiving welding sensor data from a welding operation. The method includes analyzing the welding data with respect to welding parameter thresholds to determine a correction signal based on the welding data. The method includes assigning a light wavelength value or light intensity value to the correction signal. The method includes generating light signal feedback to a welding operator based on the assigned light wavelength value or light intensity value to communicate the correction signal to the operator.

### BRIEF DESCRIPTION OF THE DRAWINGS

FIG. 1 illustrates an example system that employs light signal feedback to guide welding operations.

FIG. 2 illustrates an example of an alternative system that employs light signal feedback to guide welding operations.

FIG. 3 illustrates an example of a controller to process welding data and to provide light signal feedback to guide welding operations.

FIG. 4 illustrates an example of a tip sensor to generate welding data from a welding operation.

FIG. 5 illustrates an example of positioning a light generator within a welding helmet to communicate a correction signal for a welding operation.

FIG. 6 illustrates an example of positioning a light generator within a welding helmet or a welding mask to communicate a correction signal for a welding operation.

FIG. 7 illustrates an example of positioning a light generator outside a welding helmet or welding mask to communicate a correction signal for a welding operation.

FIG. 8 illustrates an example of positioning a light generator near a work piece to communicate a correction signal for a welding operation.

FIG. 9 illustrates example weld interface to adjust weld parameter and feedback settings.

FIG. 10 illustrates an example method that generates light signal feedback to guide welding operations.

### DETAILED DESCRIPTION

This disclosure relates to a welding control system using light signal feedback to guide welding operations. A welding and control system are provided where welding sensor data is monitored in view of predetermined welding threshold parameters such as torch speed and torch angle, for example. Automated peripheral light feedback signals are provided to an operator to allow them to make welding corrections in real time based on deviations from sensor data as determined with respect to the welding parameters. The light feedback can be provided as different intensities of a given wavelength and/or as different colors over a range of wavelengths. For instance, if the operator is proceeding according to desired weld travel speeds, a green light, outside the line of sight of the operator can be detected and sensed by the operator (e.g., in their peripheral vision). This type of feedback lets the operator know his speed is correct while not distracting from the welding task at hand as with current systems. For example, disruptions with current display feedback systems such as placing distractive information including numbers, symbols, and/or text in the operator's line of sight are avoided by the light generator feedback described herein leading to an overall improvement in weld quality.

If weld travel speed deviates, the light signal feedback can gradually change to another color (or intensity) such as yellow gently letting the operator know a correction is needed while not interfering with his concentration at the given welding joint. A sensor associated with the welding tip monitors the welding parameters during the welding process. A welding helmet (or other apparatus) receives light signal feedback from the welding process where the light signal feedback is positioned outside of the line of sight of the operator so as to mitigate distraction to the welding process at hand. A controller compares the welding parameters from the sensor to a threshold value and notifies an operator via the light signal feedback if one or more of the welding parameters exceeds the threshold value in order to facilitate a change in the welding process. The welding parameter can be, for example, a tip angle, a tip speed, or a tip distance from a location of a weld at the joining materials.

In one example, a color-coded light generator (e.g., multicolor incandescent, LED light, or laser responsive to a control signal) can be placed inside the welding helmet (or near the welding helmet) in the welder peripheral vision that would not distract from watching the welding arc as with conventional systems during the welding process. This would gently alert the welder without disturbing the process as with current audio and/or information display systems that are embedded in the line of sight of the respective weld. Thus, light signal feedback can be positioned outside the line of sight, when the travel speed and/or welding torch angle is within parameter thresholds, about to drift out of parameter threshold, and out of parameter thresholds, using a red-yellow-green light (or other wavelengths of light) feedback to signal these conditions. For example, the light feedback could become greener when the welding condition is being corrected, or more yellow to red (or other color) if the condition worsens. The control system allows the welder to continue welding but also allows the welder to correct the weld travel speed and/or angle in real time while welding. This avoids unneeded starts and stops that may occur due to audio alarms and/or visual display events which tend to cause weld discontinuities.

The sensor for the welding torch can be attachable to a variety of different welding torches and processes and can clamp on using a strap attachment (e.g., velcro or metal clamps), for example. The sensor can be calibrated to its home position to accurately and gently notify the welder when parameters are out of the allowable speeds and angles. The helmet feedback can be wireless and can be fastened into a variety of different welding helmet styles (or masks), such that it could be used with existing helmets (or masks). This system can be a standalone, add-on to existing welding torches and helmets and does not require an interface to the welding power source.

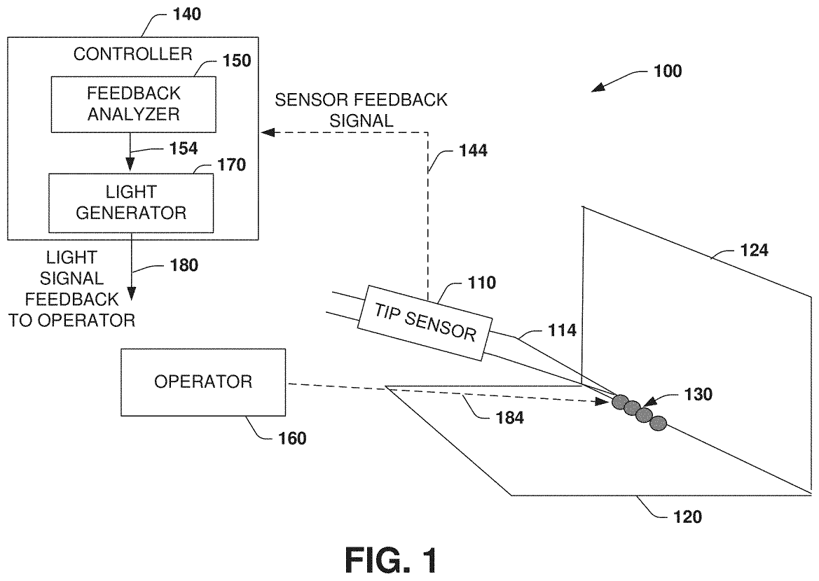

FIG. 1 illustrates an example system 100 that employs light signal feedback to guide welding operations. The system 100, also referred to as a welding control system includes a tip sensor 110 to collect welding data from a welding tip 114. As shown, the welding tip 114 is joining two materials 120 and 124 (could be more than two) by applying a series of welding beads shown at 130 to form a continuous weld. A controller 140 receives the welding data from the tip sensor 110 as a sensor feedback signal 144. The controller 140 includes a feedback analyzer 150 to compare the welding data received in the sensor feedback signal 144 to welding parameter thresholds to determine a correction signal 154 based on the welding data. As used herein, the term correction signal refers to a signal that indicates how closely a weld operator shown at 160 has guided a respective welding operation such as shown at 130 according to the welding parameter thresholds described herein. A light generator 170 generates light signal feedback 180 to the welding operator 160 in response to the correction signal 154.

As used herein, the term light generator refers to a device that can communicate a wavelength of light or an intensity value (e.g., brighter or darker) for a given wavelength. The light generator 170 as referred to herein is not a display and thus cannot communicate information such as numbers, letters, and/or symbols to the operator 160. Moreover, the light generator 170 can be positioned outside the line of sight of the operator 160 which is represented by viewing line 184. Thus, the operator 160 in many instances, does not actually see the light generator 170 but can nonetheless observe its output in an indirect manner in their peripheral vision to gently sense the light feedback signal 180 and thus avoid any type of distraction within the line of sight at 184. This type of indirect communications by the wavelength or intensity of light is in contrast to prior systems that can disrupt welding operations within line-of-sight with disruptive display symbols/information and/or with the use of abrupt audio alarms which can in turn affect the quality of the weld at 130.

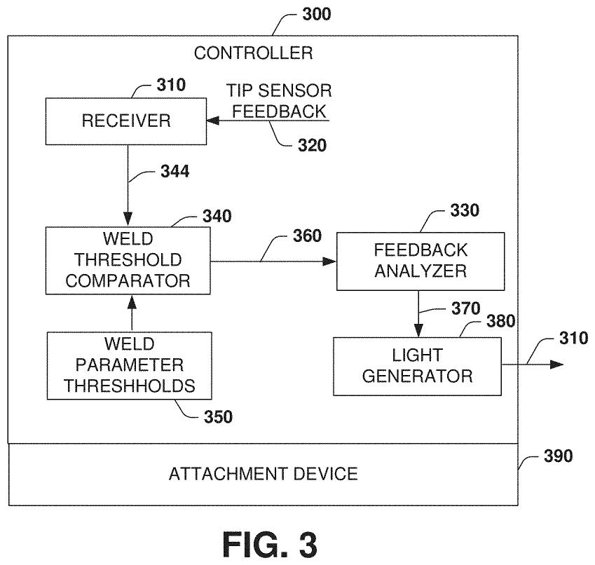

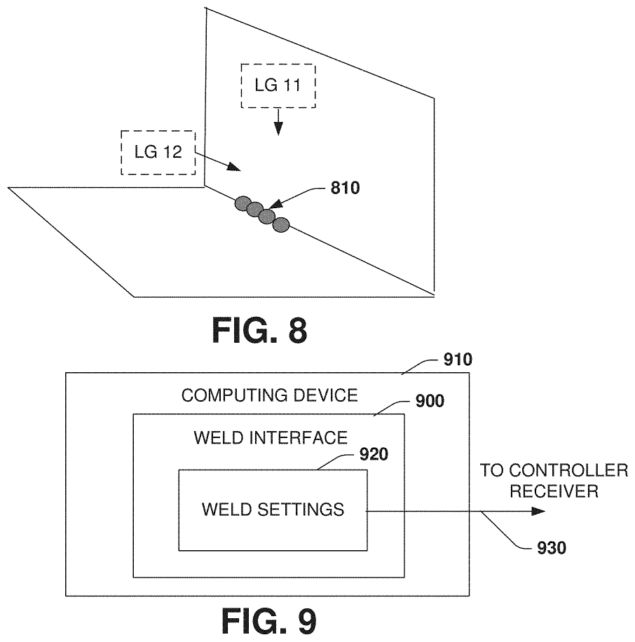

The controller 140 (or light generator) can include an attachment device (see e.g., FIG. 3) to position the light generator 170. For example, the light generator 170 can be positioned outside the line of sight 184 of the welding operator 160 with respect to an area defined by a viewing window of a welding mask or welding helmet. Also, the light generator 170 can be positioned by the attachment device inside the welding helmet or welding mask, positioned outside the welding helmet or welding mask, or positioned near the welding joint 130 such that light from the light generator can illuminate the welding joint (see e.g., FIG. 8).

The light generator 170, for example, can be at least one of a light emitting diode (LED), a laser, a wavelength division multiplexer, a set of light bulbs having different colors in the set, and a color bar. This includes any type of generator that can generate differing wavelengths of light and/or vary the intensity of light. Thus, the correction signal 154 can be encoded as different wavelength values to communicate the correction signal to the operator 160. In one example, a green light provided by the light signal feedback at 180 may indicate that the given welding operation is within desired welding parameters. If the operator 160 begins to drift outside of desired welding parameters, the light signal feedback 180 can gently change from one color to another to notify the operator that a correction should occur. For example, a darker color may indicate the weld travel speed is too fast whereas a lighter color may indicate the weld travel speed is too slow. Similar types of light feedback can be employed for other welding parameters such as torch/tip angle and welding tip to workpiece distance for example.

For operators who may have trouble reacting to different colors (e.g., due to some form of color-blindness), the intensity of the light feedback signal 180 can be varied. For example, if the operator is within desired welding parameters, a brighter light at a given wavelength can be communicated whereas if the operator drifts outside of desired parameters, the intensity of the light feedback signal 180 can be reduced to indicate such drift.

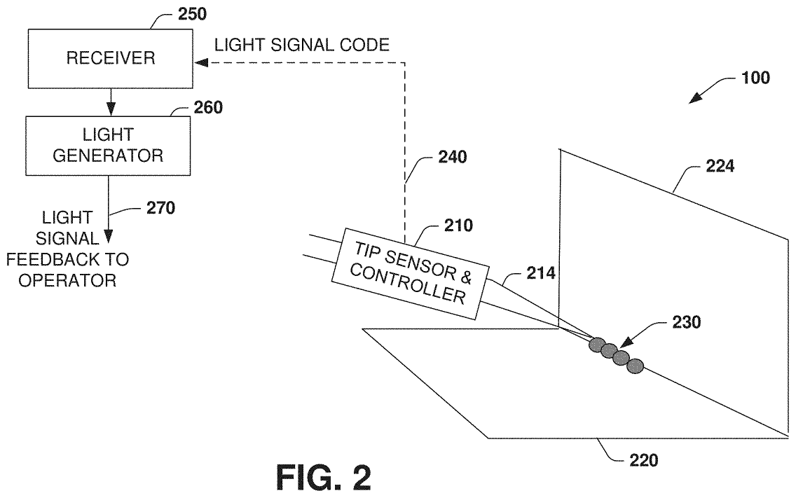

In one example, (see e.g., FIG. 2), the controller 140 can be located with the tip sensor 110 to communicate a light signal code to a wireless receiver that communicates with the light generator 170. In other examples, the controller 140 can be located with the light generator 170 as shown and process the welding data received from the tip sensor 110 to generate the light signal feedback 180. In still yet other example implementations, some processing and control may be distributed between the tip sensor 110 and the controller 140.

FIG. 2 illustrates an example of an alternative system 200 that employs light signal feedback to guide welding operations. The system 200 employs a tip sensor and controller 210 to collect and process welding data from a welding tip 214. As shown, the welding tip 214 is joining two materials 220 and 224 by applying a series of welding beads shown at 230 to form a continuous weld. A controller integrated with the tip sensor 210 receives and processes the welding data from the tip sensor and provides a light signal code 240 representing a correction signal relating to the given welding operation. The controller in the tip sensor 210 can include a feedback analyzer to compare the welding data received from the tip sensor 210 to welding parameter thresholds to determine a correction signal based on the welding data, where the correction signal is encoded as the light signal code 240. A receiver 250 (e.g., wireless receiver) receives the light signal code 240 from the tip sensor and controller 210. A light generator 260 generates light signal feedback 270 to the welding operator.

The receiver 250 and light generator 260 can include an attachment device to position the light generator. For example, the light generator 260 can be positioned outside the line of sight of the welding operator with respect to an area defined by a viewing window of a welding mask or welding helmet as mentioned previously. Similarly, the receiver 250 and/or light generator 270 can be positioned by the attachment device inside the welding helmet or welding mask, positioned outside the welding helmet or welding mask, or positioned near the welding joint 230 such that light from the light generator can illuminate the welding joint. As mentioned above, in some example implementations, some form of processing and/or control decision-making can be implemented at the tip sensor 210 and remotely at the receiver 250 and light generator 270 such that collective processing of welding data is performed at both the transmitting end and the receiving end illustrated by the system 200.

FIG. 3 illustrates an example of a controller 300 to process welding data and to provide light signal feedback to guide welding operations. As shown, the controller 300 includes a receiver to acquire welding data from tip sensor feedback received at 320. The controller 300 includes a feedback analyzer 330 and weld threshold comparator 340. The weld threshold comparator 340 monitors welding data 334 from the receiver 310 with respect to weld parameter thresholds 350 to generate a comparator output signal 360. The feedback analyzer 330 monitors the comparator output signal 360 to determine a wavelength value or wavelength intensity value 370 for a light generator to provide a light feedback signal 384. The parameter thresholds 350 can be set for desired tip speed, tip angle, and/or angle distance and can be adjusted by the interface described with respect to FIG. 9. As shown, an attachment device 390 can be provided to position the light generator 380. The light generator 380 can be positioned outside the line of sight of the welding operator with respect to an area defined by a viewing window of a welding mask or welding helmet, for example. The attachment device can include Velcro, tape, double-sided sticky tape, metal or plastic clamps, and/or cable ties for example.

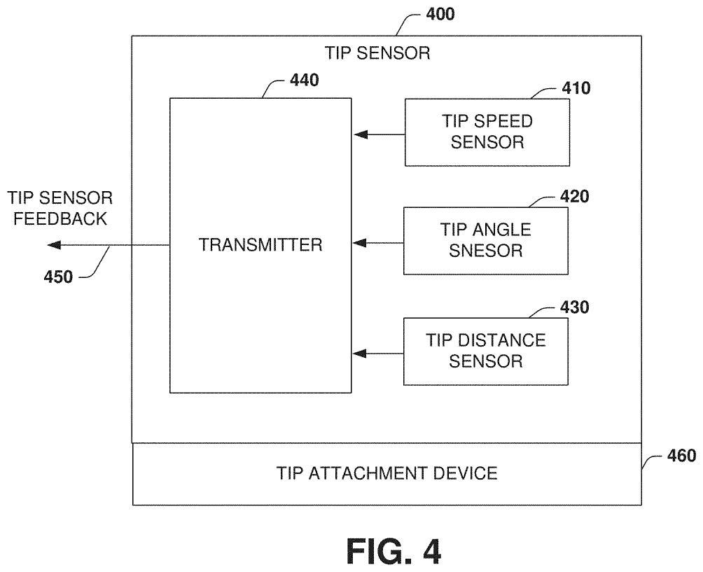

FIG. 4 illustrates an example of a tip sensor 400 to generate welding data from a welding operation. As shown, the tip sensor 400 can include at least one of a travel speed sensor 410, a tip angle sensor 420, or a tip distance-to-workpiece sensor 430. A transmitter 440 (e.g., wireless) can receive sensor data from the sensors 410 through 430 and provide tip sensor feedback 450 which can be received remotely by the receivers and/or controllers described herein. By way of example, the travel speed sensor 410 can be an accelerometer, the tip angle sensor 420 can be a gyroscope, and the tip distance-to-workpiece sensor 430 an infrared distance sensor. The tip angle sensor 420 can include multiple gyroscopes to monitor different axis of tip rotation.

The transmitter 440 associated with the tip sensor 400 communicates the welding data detected by the tip sensor via the feedback signal 450. A tip attachment device 460 can be provided to enable attachment of the tip sensor 400 to the welding tip. Since higher temperatures may be involved, the tip attachment device 460 can include metal clamps and/or polymer material clamps suitable for use at higher temperatures.

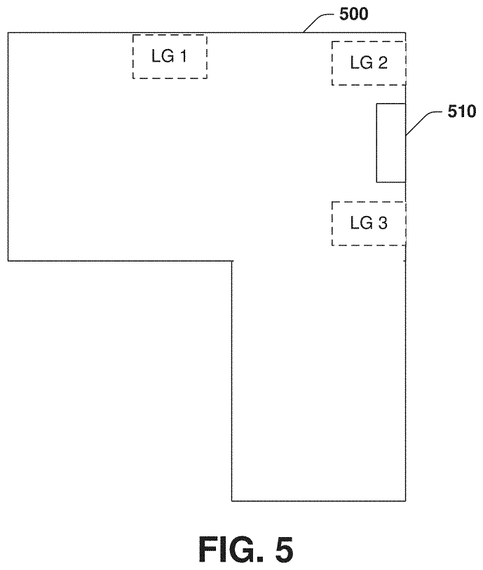

FIG. 5 illustrates an example of positioning a light generator within a welding helmet 500 to communicate a correction signal for a welding operation. In this example, the welding helmet includes a welding viewing window 510 for viewing a given welding operation as described herein. Example positions for the light generators described herein are shown as LG1 positioned above the welder's head, LG2 positioned above the viewing window 510, and LG3 positioned below the viewing window. Other light generator positions are possible that also do not interfere with the welding operator's line of sight to the respective welding location.

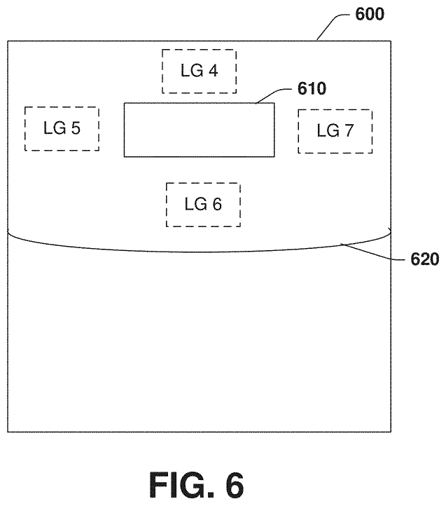

FIG. 6 illustrates an example of positioning a light generator within a welding helmet or a welding mask to communicate a correction signal for a welding operation. In this example, a backside view of a welding helmet or welding mask 600 is shown and providing a viewing window at 610. As shown, four example positions for a light generator as described herein can be located respectively at LG4, LG5, LG6, and LG7. Other positions situated diagonally to the viewing window 610, for example, are possible. In a mask application, a strap 620 can be provided to secure the mask to the welder's head.

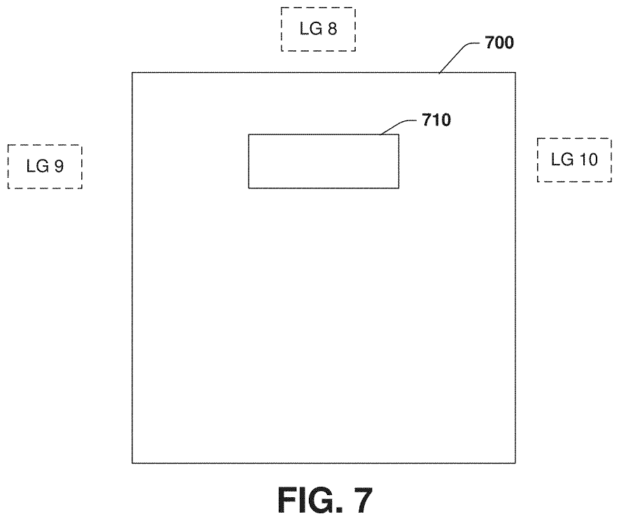

FIG. 7 illustrates an example of positioning a light generator outside a welding helmet or welding mask 700 to communicate a correction signal for a welding operation. In this example where the mask or helmet 700 includes a viewing window 710, light generators are positioned at example locations LG8, LG9, and LG10 that are located outside of the respective helmet or mask. Thus, in this example, as the welder is performing a given weld, the welder can be corrected via the correction and feedback signals described herein based on light signals that are generated within proximity of the mask or helmet yet can still be detected by the welder in their peripheral vision. As noted previously, other example positions for light generator positioning outside the mask are possible.

FIG. 8 illustrates an example of positioning a light generator near a work piece to communicate a correction signal for a welding operation. In this example, light generators shown as LG11 and LG12 are positioned to provide corrective feedback by illuminating an area near where a weld is being performed such as shown at 810. The light generators LG11 and LG12 would not be visible in the welder's line of site while performing a given weld, however light generated from such placement can be visible in the welder's peripheral vision to communicate desired corrective and/or other feedback information.

FIG. 9 illustrates example weld interface 900 to adjust weld parameter and feedback settings. The weld interface 900 is operative with the controllers described herein. As shown, the weld interface 900 can be executed on a computing device 910. The computing device 910 can include cell phones, personal computing devices, desk top computer, laptop computers, and/or other computing technology. The weld interface 900 allows adjustments to weld settings 920 which can be wirelessly communicated to a controller receiver (or tip senor controller) via wireless signal 930. The weld setting can include the weld parameter thresholds described herein such as setting desired speed, torch angle, and distance settings previously described. Other weld settings 920 can include the colors or intensities associated with the light signal feedback. For instance, the settings can select the color of light when welding operations are within desired parameter thresholds and allow for specifications of other colors when outside of desired thresholds. This can include adjusting the type of light feedback provided from the light generator. For example, for those who may have trouble discerning different colors, wavelength intensities can be specified for one specific color to communicate desired feedback information from the welding operation (e.g., bright light at given wavelength indicates parameter thresholds are being met whereas dimmer light of the same wavelength indicates parameter thresholds are being exceeded).

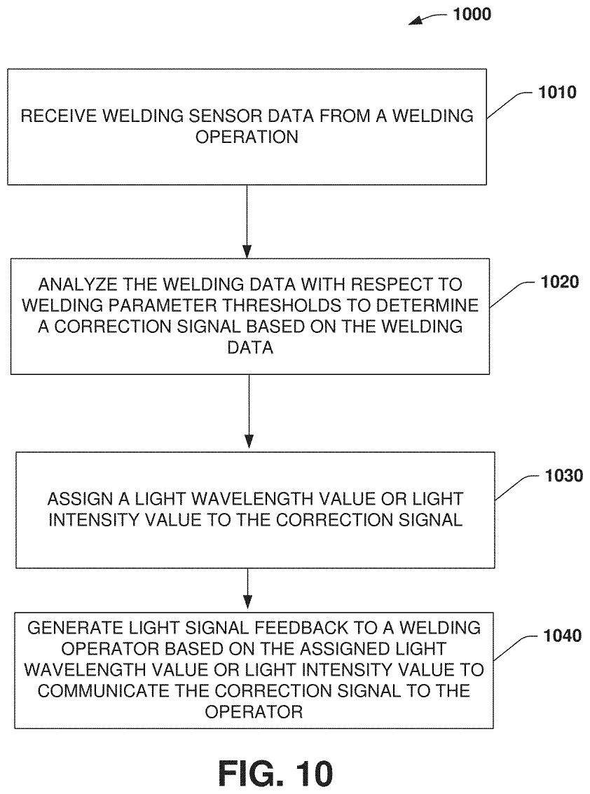

In view of the foregoing structural and functional features described above, an example method will be better appreciated with reference to FIG. 10. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by a processor or controller executing machine-readable instructions from a computer-readable medium.

FIG. 10 illustrates an example method 1000 that generates light signal feedback to guide welding operations. At 1010, the method 1000 includes receiving welding sensor data from a welding operation. At 1020, the method 1000 includes analyzing the welding data with respect to welding parameter thresholds to determine a correction signal based on the welding data. At 1030, the method 1000 includes assigning a light wavelength value or light intensity value to the correction signal. At 1030, the method 1000 includes generating light signal feedback to a welding operator based on the assigned light wavelength value or light intensity value to communicate the correction signal to the operator. Although not shown, the method can also include transmitting the welding sensor data from a tip sensor. The tip sensor includes at least one of a travel speed sensor, a tip angle sensor, or a tip distance-to-workpiece sensor, for example.

What has been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A welding control system, comprising:
a tip sensor to collect welding data from a welding tip;
a controller to receive the welding data from the tip sensor, the controller compares the welding data to welding parameter thresholds to determine a correction signal based on the welding data; and
a light generator to generate light signal feedback to a welding operator in response to the correction signal.

2. The system of claim 1, further comprising an attachment device to position the light generator, wherein the light generator is positioned outside the line of sight of the welding operator with respect to an area defined by a viewing window of a welding mask or welding helmet.

3. The system of claim 2, wherein the light generator is positioned by the attachment device inside the welding helmet or welding mask, positioned outside the welding helmet or welding mask, or positioned near a welding joint such that light from the light generator can illuminate the welding joint.

4. The system of claim 1, wherein the light generator is at least one of a light emitting diode (LED), a laser, a wavelength division multiplexer, a set of light bulbs having different colors in the set, and a color bar.

5. The system of claim 1, wherein the tip sensor includes at least one of a travel speed sensor, a tip angle sensor, or a tip distance-to-workpiece sensor.

6. The system of claim 5, wherein the travel speed sensor is an accelerometer, the tip angle sensor is a gyroscope, and the tip distance-to-workpiece sensor is an infrared distance sensor.

7. The system of claim 1, further comprising a wireless transmitter associated with the tip sensor to communicate the welding data and a wireless receiver associated with the light generator.

8. The system of claim 7, wherein the controller is located with the tip sensor to communicate a light signal code to the wireless receiver, or the controller is located with the light generator and the wireless receiver and processes the welding data received from the tip sensor to generate the light signal feedback.

9. The system of claim 1, wherein the controller includes a feedback analyzer and weld threshold comparator, the weld threshold comparator monitors the welding data with respect to weld parameter thresholds to generate a comparator output signal, and the feedback analyzer monitors the comparator output signal to determine a wavelength value or wavelength intensity value for the light generator.

10. The system of claim 1, further comprising a tip attachment device to enable attachment of the tip sensor to the welding tip.

11. The system of claim 1, further comprising a weld interface operative with the controller, the weld interface allows adjustments to the weld parameter thresholds and the colors or intensities associated with the light signal feedback.

12. A device, comprising:
a wireless receiver to receive welding data from a welding operation;
a controller to analyze the welding data with respect to welding parameter thresholds to determine a correction signal based on the welding data;
a light generator to generate light signal feedback to a welding operator in response to the correction signal, the light signal feedback includes a variable wavelength of light or variable intensity of light to communicate the correction signal; and
an attachment device to position at least the light generator in a welding helmet or welding mask.

13. The device of claim 12, wherein the light generator is at least one of a light emitting diode (LED), a laser, a wavelength division multiplexer, a set of light bulbs having different colors in the set, and a color bar.

14. The device of claim 12, wherein the welding data is received from a tip sensor that includes at least one of a travel speed sensor, a tip angle sensor, or a tip distance-to-workpiece sensor.

15. The device of claim 14, wherein the travel speed sensor is an accelerometer, the tip angle sensor is a gyroscope, and the tip distance-to-workpiece sensor is an infrared distance sensor.

16. The device of claim 14, further comprising a wireless transmitter associated with the tip sensor to communicate the welding data to the wireless receiver.

17. The device of claim 12, wherein the controller includes a feedback analyzer and weld threshold comparator, the weld threshold comparator monitors the welding data with respect to weld parameter thresholds to generate a comparator output signal, and the feedback analyzer monitors the comparator output signal to determine a wavelength value or wavelength intensity value for the light generator.

18. The device of claim 12, further comprising a weld interface operative with the controller, the weld interface allows adjustments to the weld parameter thresholds and the colors or intensities associated with the light signal feedback.

19. A method, comprising:
receiving welding sensor data from a welding operation;
analyzing the welding data with respect to welding parameter thresholds to determine a correction signal based on the welding data;
assigning a light wavelength value or light intensity value to the correction signal; and
generating light signal feedback to a welding operator based on the assigned light wavelength value or light intensity value to communicate the correction signal to the operator.

20. The method of claim 19, further comprising transmitting the welding sensor data from a tip sensor, wherein the tip sensor includes at least one of a travel speed sensor, a tip angle sensor, or a tip distance-to-workpiece sensor.
